(19) United States
(12) Patent Application Publication
(10) Pub. No.: US 2014/0208594 A1
(43) Pub. Date: Jul. 31, 2014

(54) Hooded Box Cutter

(71) Applicants: Thomas Scimone, Campbell, CA (US); Kenneth Robertson, San Jose, CA (US); Jacques Gagne, Los Gatos, CA (US); Scot Herbst, Santa Cruz, CA (US)

(72) Inventors: Thomas Scimone, Campbell, CA (US); Kenneth Robertson, San Jose, CA (US); Jacques Gagne, Los Gatos, CA (US); Scot Herbst, Santa Cruz, CA (US)

(21) Appl. No.: 13/753,000

(22) Filed: Jan. 29, 2013

(51) Int. Cl. B67B 7/46

(52) U.S. Cl. CPC B67B 7/30
USPC 30/2

(57) ABSTRACT

The present invention generally relates to a box cutter. Specifically, embodiments of the present invention relate to a box cutter apparatus with an auto-locking blade guard. Embodiments of the box cutter apparatus are further comprised of a handle guard designed to protect the hand of a user.

### FIELD OF THE INVENTION

The present invention generally relates to a box cutter. Specifically, embodiments of the present invention relate to a box cutter apparatus with an auto-locking blade guard. Embodiments of the box cutter apparatus are further comprised of a handle guard designed to protect the hand of a user.

### BACKGROUND

The box cutter is tool familiar to many people, as its use is common in both the commercial and consumer markets. Typical box cutters utilize a either a sliding or folding blade to store the blade when it is not in use. Additionally, a standard box cutter requires the user to wrap their hand around the entire body of the box cutter. These design features create safety issues with the typical box cutter.

First, the sliding or folding blade requires the user to extend and retract the blade each time it is used. This leaves the blade exposed for extended periods of time, increasing the chance of injury. Further, as it is commonly operated, users will leave the blade extended while they perform their work, potentially forgetting to retract the blade after the work is completed. The resulting safety hazard is palpable and results in numerous injuries every year.

Second, in common embodiments where the handle of a box cutter is a substantially straight rectangular device which a user wraps their hand completely around, a user risks that the handle will slip through their hand and cause an injury when the blade is extended. Additionally, straight handled box cutters can come loose from the user's hand either in a forward motion, presenting danger to objects and persons in front of the user, or in a rearward motion, presenting danger to the user and those objects and persons behind the user.

Therefore, there is a need in the art for a box cutter that provides blade and handle safety features to prevent user and bystanders from accidental injuries. These and other features and advantages of the present invention will be explained and will become obvious to one skilled in the art through the summary of the invention that follows.

### SUMMARY OF THE INVENTION

Accordingly, it is an aspect of the present invention to provide box cutter with a hooded blade that automatically secures the blade beneath the hood after the blade has left a cutting surface. Further, it is an aspect of the present invention to provide a box cutter with a looped handle that provides a secure grip and reduces the possibility of unintentional releases.

According to an embodiment of the present invention, a hooded box cutter includes: a main body shell comprising a handgrip; an internal frame substantially contained within the main body shell; a blade receptacle attached to a leading end of the internal frame, wherein the blade receptacle is configured to retain a box cutter blade; a blade guard that is movable between at least two positions; and a blade guard release mechanism which is integrated with the internal frame and configured to disengage a locking means; wherein when the blade guard is in a first position of the at least two positions, the blade guard covers the blade receptacle such that no portion of the box cutter blade is exposed and the blade guard is prevented from moving into any other position by the locking means without first disengaging the locking means by way of the blade guard release mechanism, and wherein a second position of the at least two positions is entered upon utilization of the blade guard release mechanism to disengage the locking means and forcibly applying the blade guard to a cutting surface such that the blade guard is pushed upward and the box cutter blade is exposed.

According to an embodiment of the present invention, the main body shell further comprises a lower hand guard portion, being formed below the handgrip and configured to prevent contact between the cutting surface and a hand of an operator of the hooded box cutter.

According to an embodiment of the present invention, the handgrip and the lower hand guard portion are connected, forming a cavity between.

According to an embodiment of the present invention, the cavity between the handgrip and lower hand guard form an elliptical shape.

According to an embodiment of the present invention, a backstop is formed on the main body shell, preventing the blade guard from exposing the box cutter blade.

According to an embodiment of the present invention, the blade guard release mechanism comprises a release means and a tension means.

According to an embodiment of the present invention, the release means is selected from the group comprising a button, a trigger, a switch and a thumb slider.

According to an embodiment of the present invention, the tension means is selected from the group comprising leaf springs, compression springs, slider bars and pins.

According to an embodiment of the present invention, the blade receptacle is further configured to allow the box cutter blade to be released in a manner that allows the box cutter blade to be removed from the blade receptacle.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a perspective view of a box cutter in accordance with an embodiment of the present invention;

FIG. 2 is a side view of a box cutter in accordance with an embodiment of the present invention;

FIG. 3 is an exploded view of a box cutter in accordance with an embodiment of the present invention;

FIG. 4 is an exploded view of a box cutter in accordance with an embodiment of the present invention;

FIG. 5 is a perspective view of a box cutter in accordance with an embodiment of the present invention;

FIG. 6 is a side view of a box cutter in accordance with an embodiment of the present invention;

FIG. 7 is an exploded view of a box cutter in accordance with an embodiment of the present invention; and

FIG. 8 is an exploded view of a box cutter in accordance with an embodiment of the present invention;

FIG. 9 is a side view of a box cutter in accordance with an embodiment of the present invention.

### DETAILED SPECIFICATION

The present invention generally relates to a box cutter. Specifically, embodiments of the present invention relate to a box cutter apparatus with an auto-locking blade guard. Embodiments of the box cutter apparatus are further comprised of a handle guard.

According to an embodiment of the present invention, the box cutter described herein is comprised of a main body shell, a blade guard, an internal frame, a blade receptacle, a blade, a and a blade guard release mechanism. Certain embodiments of the present invention may include fewer components or additional components depending on the utilization and purpose for the box cutter.

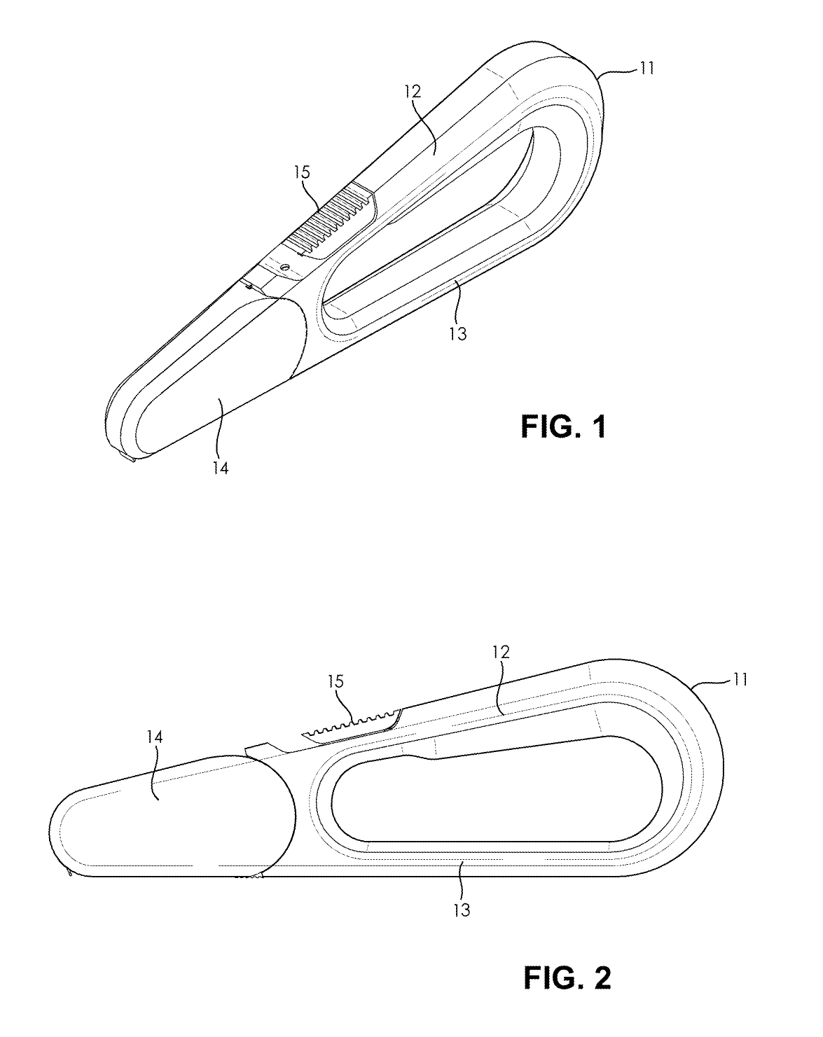

According to an embodiment of the present invention, the main body shell of the box cutter is configured to receive and retain the blade guard, the internal frame, the blade receptacle, the blade, and the blade guard release mechanism. In a preferred embodiment, the main body shell may include two semi-hollow halves configured to house the internal frame when connected together. The preferred embodiment of the main body shell may be flat and roughly oval in shape cavity in the middle, forming a handle grip (See FIG. 1). Other embodiments of the present invention the main body shell may be formed from a single component with the internal frame being either integrally formed within or removably attached to the single component main body shell. In further embodiments, the main body shell may be comprised of any number of components, attached together to form a handle capable of receiving, or having integrally formed upon it, the internal frame.

Preferred embodiments of the present invention are configured such that the handle formed by the main body shell provides at least a handgrip portion of the handle and a lower hand guard portion configured to protect a user's hand while operating the box cutter. Advantageously, the hand grip portion allows for secure holding of the box cutter while the lower hand guard portion protects the user from cuts or abrasions that may occur from continual operation of the box cutter on or near cutting surfaces. Finally, the closed back of the preferred oval handle design further allows the device to be attached or secured when the box cutter is not in use. For instance, the box cutter can be hung on a hook or attached to a clip or other securing device attached to the clothing or other wearable accessory of the user. While embodiments of the present invention are depicted as oval or substantially oval, one of ordinary skill in the art would appreciate that the handle could be formed in any shape allowing for formation of a handgrip and lower hand guard portion, such as a square, rectangle, triangle, polygon, ellipses or any other shape. In other embodiments, only a handgrip is required without the need for a lower hand guard portion.

According to an embodiment of the present invention, the box cutter includes an internal frame. In a preferred embodiment, the internal frame may be configured to receive the blade receptacle and the blade guard release mechanism. In alternate embodiments, fewer or additional components may be received upon the internal frame. For instance, in certain embodiments, the blade guard release mechanism could be retained upon the main body shell as opposed to the internal frame. In other embodiments, the blade receptacle could be received upon the main body shell as opposed to the internal frame.

According to an embodiment of the present invention, the internal frame may be retained in or on the main body shell by way of an attachment means. Attachment means that could be utilized with embodiments of the present invention include, but are not limited to, friction fits, epoxies, adhesives, bolts, screws, pins, rivets, or any combination thereof. One of ordinary skill in the art would appreciate that there are numerous attachment means that could be utilized with embodiments of the present invention, and embodiments of the present invention are contemplated for use with any type of attachment means. Further, the internal frame may be integrally formed upon the main body shell, removably attached to the main body shell, partially removable from the main body shell (e.g., one or more of the sub-components of the internal frame being removable from the main body shell), permanently affixed to the main body shell or semi-permanently affixed to the main body shell.

In a preferred embodiment, the internal frame may be secured to one of the semi-hollow halves of the main body shell with an attachment means comprising one or more fasteners. The remaining semi-hollow half of the main body shell may then be connected to the first half of the main body by fitting around the internal frame. The connection of the two-halves of the main body shell encloses the internal frame within the main body shell, holding the internal frame securely in place.

According to an embodiment of the present invention, the box cutter includes a blade guard. In a preferred embodiment of the present invention, the blade guard may be coupled to the main body shell and the internal frame in a manner that allows the blade guard to rotate and expose the blade. The blade guard may be substantially hollow and formed in a shape such that the blade receptacle and blade are completely encompassed when the box cutter is not engaged. In a preferred embodiment of the present invention the blade guard will automatically lock into place around the blade when the blade is removed from the cutting surface. The locking of the blade guard may be accomplished through one or more locking means, including, but not limited to, a hard stop, a swing arm, lock back, or any combination thereof. One of ordinary skill in the art would appreciate that there are numerous locking means that could be utilized with embodiments of the present invention, and embodiments of the present invention are contemplated for use with any locking means.

Further, in certain embodiments, once the box cutter has been removed from the cutting surface the blade guard will remain locked until the blade guard release mechanism is operated again to unlock the blade guard. As such, once the blade guard has left the cutting surface, the blade guard will lock and remain locked until the lock is disengaged by use of the blade guard release mechanism.

According to an embodiment of the present invention, a blade receptacle is attached to the internal frame of the box cutter. In a preferred embodiment of the present invention, the blade receptacle is configured to retain a blade in a secured manner. Blades for use in embodiments of the present invention include, but are not limited to, ceramic box cutter blades, steel box cutter blades and composite box cutter blades. One of ordinary skill in the art would appreciate that there are numerous blades that could be utilized with embodiments of the present invention, and embodiments of the present invention are contemplated for use with any such blades. In preferred embodiments of the present invention, the blade receptacle may be disengaged to allow for the blade to be replaced when the blade dulls, breaks or otherwise becomes unusable.

In an alternate embodiment of the present invention, the internal frame may be attached to the main body shell in a manner that forms a scissor-like mechanism that is configured to allow the blade receptacle portion of the internal frame to disengage from its blade guard covering, allowing for the blade to be replaced easily and conveniently before being moved back into a secure closed position for operation. In a preferred embodiment, the internal frame includes one or more hinges that enable the internal frame to pivot up and down in the aforementioned scissor-like manner. The sliding motion that is created allows for the majority of the internal frame to be lowered out of and raised into the main body shell, thereby providing convenient access to the blade receptacle.

According to an embodiment of the present invention, the blade receptacle may further include a blade adapter. In a preferred embodiment, the blade adapter may only be required when blades made of a particular material are used. As an illustrative example, the blade adapter may be required when a ceramic blade is used, whereas no blade adapter is required when a metal blade is used (or vice versa). One of ordinary skill the art would appreciate that there are numerous ways in which a blade adapter may be configured, and embodiments of the present invention are contemplated for use with any such configuration.

According to an embodiment of the present invention, the blades used in the box cutter of the present invention may be constructed from a ceramic material that is capable of withstanding extended use without becoming dull or unusable. Ceramic materials appropriate for such construction include, but are not limited to, Zirconium Oxide. One of ordinary skill in the art would appreciate that there are numerous ceramic materials that could be utilized with embodiments of the present invention. Alternatively, embodiments of the present invention may be used with standard box cutter blades. In certain embodiments, the blades used in the box cutter may contain rounded tips to reduce the chance of injury.

According to an embodiment of the present invention, the box cutter may include a blade storage space. In a preferred embodiment, the internal frame and the main body shell may be configured to include a blade storage space. In the preferred embodiment, the blade storage space may be incorporated into the internal frame and blade receptacle to allow for the storage of extra blades near the blade receptacle. The preferred embodiment may use the scissor-like mechanism of the internal frame to allow convenient and simultaneous access to both the blade receptacle and the blade storage space.

According to an embodiment of the present invention, the box cutter includes a blade guard release mechanism. In a preferred embodiment, the blade guard release mechanism includes a release means (e.g., thumb slider) and a tension means (e.g., spring) and is attached to the internal frame of the box cutter. Alternatively, the blade guard release mechanism could be attached or integrally formed in one or more other components of the present invention. In certain embodiments, the release means could be one or more of a button, a trigger, a switch, or any combination thereof. For instance, a blade guard release mechanism could be comprised of a button located on the top of the main body shell and a trigger located on an inner handgrip portion of the main body shell and work in conjunction with one another such that the blade guard would not release unless both the button and the trigger were engaged simultaneously. In a preferred embodiment, the release means is a thumb slider.

According to an embodiment of the present invention, tension means include, but are not limited to, leaf springs, compression springs, slider bars, pins and other means for applying force to the locking means of the blade guard in order to disengage the lock and allow for the blade to be exposed to a cutting surface. It should be noted that in preferred embodiments, disengaging the locking means does not automatically lift the blade cover. The blade cover is raised by applying a leading edge of the box cutter to a cutting surface, thereby causing the blade cover to be pushed upward or otherwise rotated away from the blade, allowing for cutting to begin. It should further be noted that a back stop or other means is utilized to prevent the blade cover from exposing more than a desired amount of blade.

In a preferred embodiment of the invention, a spring is attached to both the internal frame and the blade guard release mechanism. The blade guard release mechanism is attached to the internal frame in such a manner that allows the blade guard release mechanism to be moved on one or more axes on the internal frame and/or the main body shell such that operation of the blade guard release mechanism disengages the locking means of the blade guard.

The connection between the blade guard release mechanism and the spring maintains a tension on the blade guard release mechanism. The blade guard release mechanism functions by initially being engaged with the locking means of the blade guard. The tension maintained by the spring on the locking means of the guard hood works to keep the locking means locked and the blade guard in place. As the thumb slider button is pushed forward, the guard release mechanism releases the locking means on the blade guard, allowing the blade guard to rotate up and expose the blade. The user can place the box cutter on the cutting surface and release the thumb slider button. While on the cutting surface, the blade guard will remain open, allowing the user to make a cut. When the user finishes the cut, the box cutter is removed from the surface and the guard mechanism release automatically locks the blade guard in place due to the tension generated by the spring.

In preferred embodiments, the movement of the blade guard is limited such that only a small portion of the blade is exposed. The amount of blade exposed can be controlled by a cutting depth selection means, such as a dial, level, switch, button or other means configured to set and restrict the amount of blade to be exposed. Blade exposure may be set based on the purpose of cutting. For instance, opening cardboard boxes may require less cutting depth than cutting thicker packing materials. By restricting blade exposure, the chance of a user or bystander being injured is significantly reduced. Blade exposure depth can be of any depth, for instance, certain embodiments may allow for a variable blade exposure depth of one or more of about 1 mm, about 2 mm, about 3 mm, about 4 mm, about 5 mm, about 6 mm, greater than 6 mm or any combination thereof. One of ordinary skill in the art would appreciate that there are numerous blade exposure depths that could be utilized with embodiments of the present invention, and embodiments of the present invention are contemplated for use with blade exposure depths of any amount.

Turning now to FIGS. 1-2, perspective and side views of a box cutter, in accordance with an embodiment of the present invention, are shown. In these illustrations, a preferred embodiment of the present invention is shown with the blade guard 14 engaged over the blade (not shown). A main body shell 11 is shown that forms an oval shaped handle with a handgrip portion 12 and a lower hand guard portion 13. Also shown in FIGS. 1-2 is a release means 15 of the blade guard release mechanism. In these embodiments, the blade guard is unlocked when a user moves the release means 15 forward towards the blade guard 14.

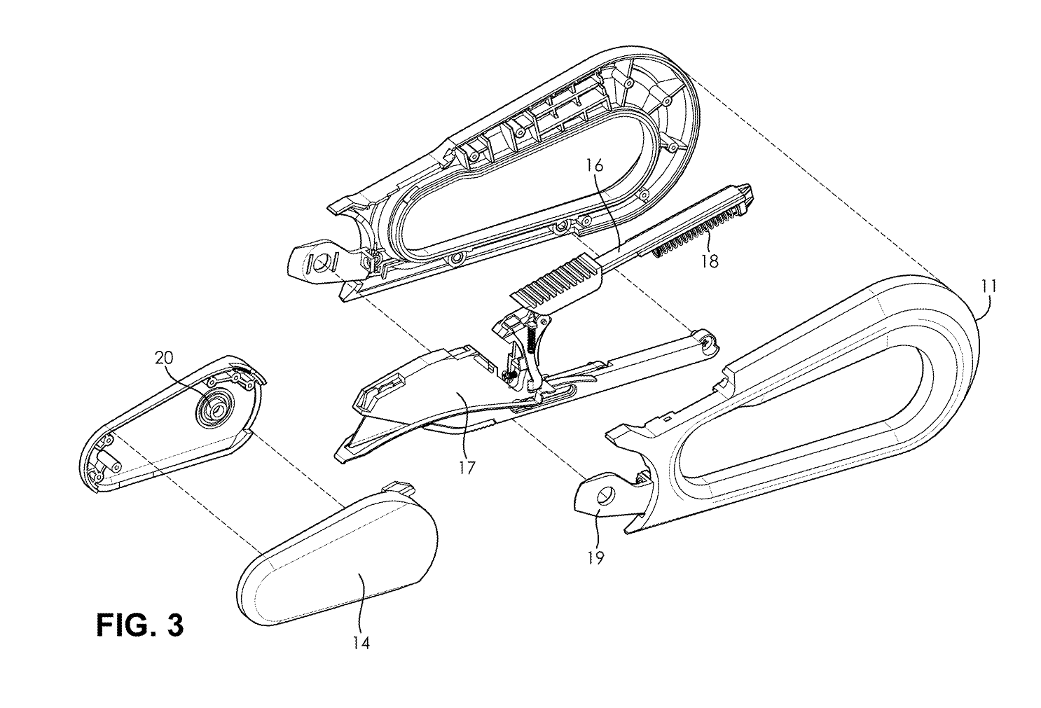

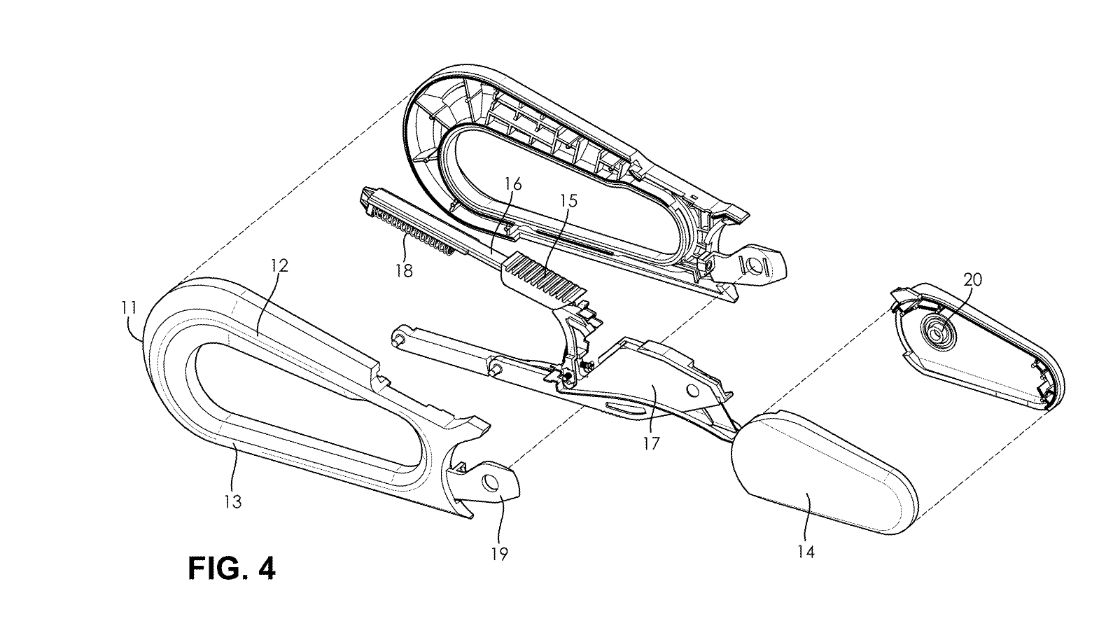

Turning now to FIGS. 3-4, exploded views of a box cutter, in accordance with an embodiment of the present invention, are shown. In these views, the various components of the present invention are shown in a disassembled manner. The main body shell 11 is shown separated, with connection points apparent in interior of the handle portion (handgrip portion 12 and lower hand guard portion 13) of the main body shell 11. In this view, the blade guard is shown as two separate pieces that are connected together via a connection means 20 that also serves to connect the blade guard 14 to a portion 19 of the locking means of the blade guard release mechanism, which is also comprised of the release means 15, and tension means 18. Finally shown is the internal frame 16 with the blade receptacle 17 retained thereupon.

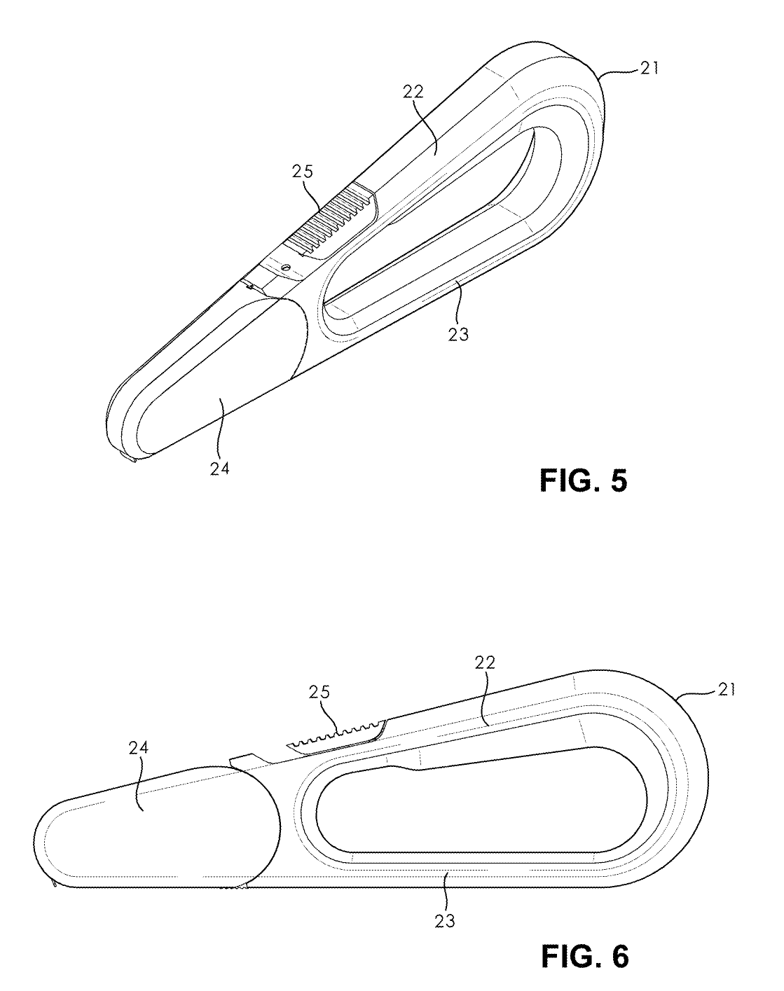

Turning now to FIGS. 5-6, perspective and side views of a box cutter, in accordance with an alternate embodiment of the present invention, are shown. In these illustrations, a preferred embodiment of the present invention is shown with the blade guard 24 engaged over the blade (not shown). A main body shell 21 is shown that forms an oval shaped handle with a handgrip portion 22 and a lower hand guard portion 23. Also shown in FIGS. 1-2 is a release means 25 of the blade guard release mechanism. In these embodiments, the blade guard is unlocked when a user moves the release means 25 forward towards the blade guard 24.

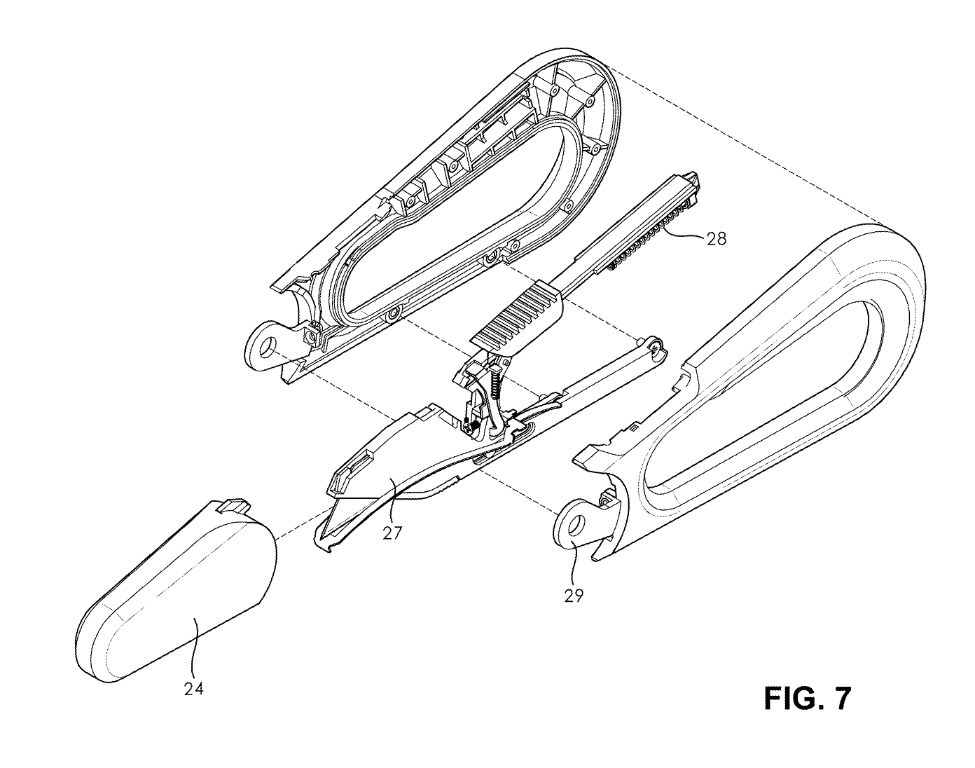

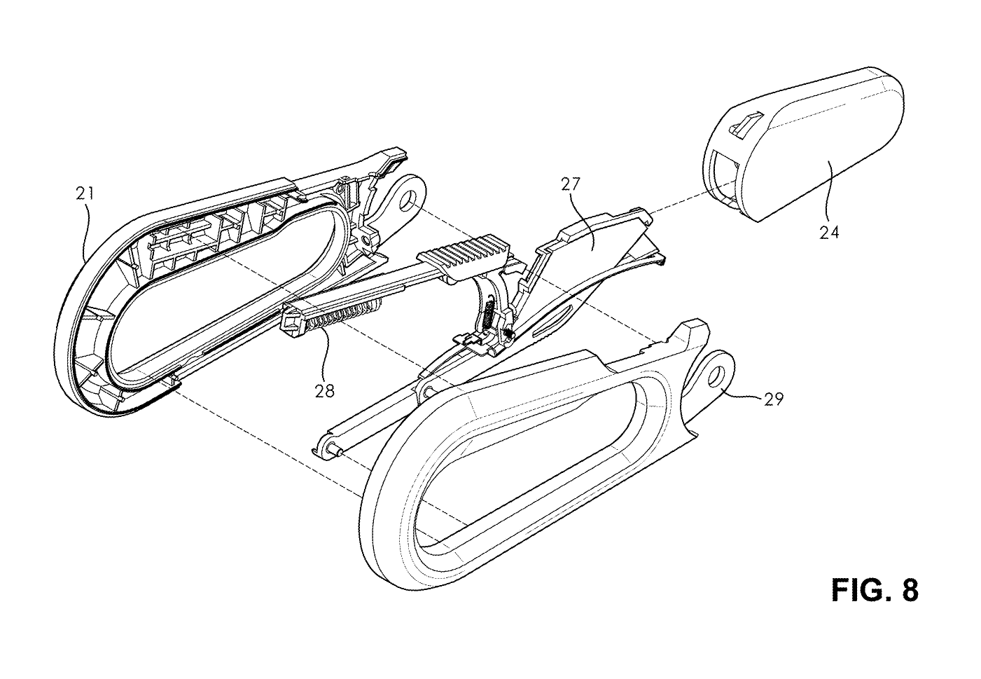

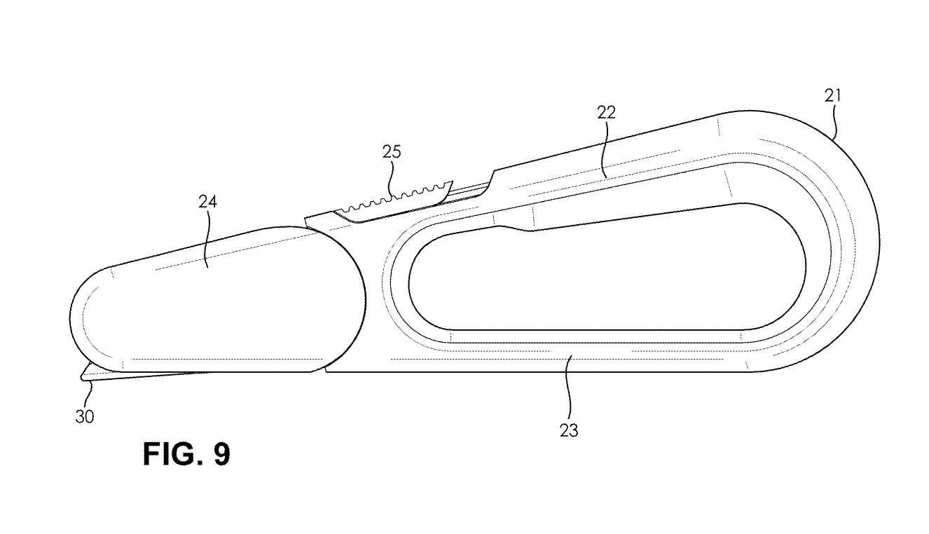

Turning now to FIGS. 7-8, exploded views of a box cutter, in accordance with an alternate embodiment of the present invention, are shown. In these views, the various components of the present invention are shown in a disassembled manner. The main body shell 21 is shown separated, with connection points apparent in interior of the handle portion (handgrip portion 22 and lower hand guard portion 23) of the main body shell 21. In this view, the blade guard is shown as a single piece that connects to a portion 29 of the main body shell configured to retain the blade guard 24 thereupon. Blade guard release mechanism components shown in these figures include release means 25 and tension means 29. Finally shown is the internal frame 26 with the blade receptacle 27 retained thereupon.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. (canceled)

2. (canceled)

3. (canceled)

4. (canceled)

5. (canceled)

6. (canceled)

7. (canceled)

8. (canceled)

9. (canceled)

10. A hooded box cutter, comprising:
a box cutter blade;
a main body shell comprising (i) a handgrip configured to encircle a hand of a user with a lower hand portion being formed below a top portion of the handgrip in order to prevent contact between a cutting surface and a hand of an operator and (ii) a locking means configured to allow for the concealment of the box cutter blade;
an internal frame substantially contained within the handgrip comprising of a blade guard release mechanism;
a blade receptacle attached to a leading end of the internal frame and is configured to retain the box cutter blade;
a blade guard coupled to the main body shell and variably engaged with the locking means such that the blade guard functions to cover the box cutter blade upon the engagement of the locking means;
wherein the engagement and disengagement of the locking means is controlled by the blade guard release mechanism that comprises (i) a tension means and (ii) a release means;
wherein the tension means is configured to apply tensile force to the locking means thereby engaging the locking means and maintaining the blade guard in fixed position so that the box cutter blade is covered and no portion is exposed;
wherein the release means is configured to disengage the locking means and allow for the blade guard to rotate up upon contact with a cutting surface and thereby exposing the box cutter blade for utilization.

11. The hooded box cutter of claim 1, wherein the tension means is located toward the posterior end of the internal frame

12. The hooded box cutter of claim 1, wherein the release means is centrally positioned on the internal frame.

13. The hooded box cutter of claim 1, wherein the release means is protruding onto the top of the main body shell.

14. The hooded box cutter of claim 1, wherein the release is protruding onto a side of the main body shell opposite to a cutting edge of the box cutter blade.
